(19) United States
(12) Patent Application Publication
(10) Pub. No.: US 2009/0307039 A1
(43) Pub. Date: Dec. 10, 2009

(54) SYSTEM AND METHOD FOR MANAGING WORK INSTRUCTIONS FOR VEHICLES

(76) Inventors: Nathaniel Seeds, Walnut Creek, CA (US); Frank Mazzella, Aliso Viejo, CA (US); Jack Cutler, Huntington Beach, CA (US); James Hynes, Castro Valley, CA (US); Vidyasagar Chikkala, Fremont, CA (US); Sekar Mokachandra, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/389,264

(22) Filed: Feb. 19, 2009

Related U.S. Application Data
(60) Provisional application No. 61/060,012, filed on Jun. 9, 2008.

(51) Int. Cl. G06Q 10/00

(52) U.S. Cl. 705/8

(57) ABSTRACT

A method is disclosed. The method includes receiving work instructions for a plurality of vehicles, receiving location information for the plurality of vehicles relative to an entity, and generating an order for the plurality of vehicles using the location information for the plurality of vehicles.

### CROSS-REFERENCES TO RELATED APPLICATIONS

This patent application is a non-provisional of and claims priority to U.S. Patent Application No. 61/060,012, filed on Jun. 9, 2008, which is herein incorporated by reference in its entirety.

### BACKGROUND

One of the key challenges to automation in the marine terminal industry is the perceived need for human eyes to be present and witnessing the physical movement of cargo and equipment to ensure that transport and handling operations are being carried out as planned. Errors in those processes can occur for a number of reasons. Such reasons include the wrong cargo or conveyance equipment being brought to a crane on a berth, or arriving out of a required order.

Traditional ways of identifying these exceptions-in-process require the physical presence of a worker who visually checks and records each task as it is performed, and acts to resolve any exception before a mistake is made. Workers are typically assigned to one or more cranes during the loading and unloading of cargo and equipment from a vessel (e.g., a ship).

Computer systems are available for planning the work, issuing work instructions and locating equipment, but there remains the problem of identifying that the correct action is actually occurring before an error is committed; that is, before a wrong piece of cargo or conveyance equipment arrives at a vessel, railcar or other conveyance for loading or discharge.

The search for an automation solution that can effectively eliminate the need for the presence of a worker for each conveyance is complicated by the operating environment. Substantial variation exists in the execution of the instruction, i.e., the routing and timing of the conveyance or proper selection of the item to be transported in accordance with instruction, or proper execution of the instruction between conveyances and points of rest (positions).

Illustratively, work instructions to bring cargo or cargo-conveying equipment to a ship are issued electronically to several trucks based on a planned order. The trucks may not complete that instruction and arrive at the ship in the same planned order, and may need to be physically reordered before they arrive at a crane for loading or discharge. The trucks also may not have brought the correct cargo or equipment, in which case the instruction may need to be re-executed or the truck reordered as necessary to keep the operation efficiently working. These are functions performed by workers located near each crane today. Further, if a continuous operation is desired, then there need to be additional workers employed to relieve those who go on break or lunch.

New and improved methods and systems for reducing the labor requirement, and improving operational efficiency would be desirable. Embodiments of the invention address these and other problems individually and collectively.

### SUMMARY

Embodiments of the invention include methods and systems for reducing labor requirements and increasing operational efficiency and accuracy.

One embodiment of the invention is directed to a computer-implemented method comprising receiving work instructions for a plurality of vehicles, receiving location information for the plurality of vehicles relative to an entity, and generating an order for the plurality of vehicles using the location information for the plurality of vehicles.

Another embodiment of the invention is directed to a computer-implemented method comprising receiving a selection of one or more entities to monitor, displaying an order for a plurality of vehicles for each of the one or more entities, and displaying an intended sequence for the plurality of vehicles for each of the one or more entities.

Another embodiment of the invention is directed to a computer readable medium comprising code for receiving work instructions for a plurality of vehicles, code for receiving location information for the plurality of vehicles relative to an entity, and code for generating an order for the plurality of vehicles using the location information for the plurality of vehicles.

Another embodiment of the invention is directed to a computer readable medium comprising code for receiving a selection of one or more entities to monitor, code for displaying an order for a plurality of vehicles for each of the one or more entities, and code for displaying an intended sequence for the plurality of vehicles for each of the one or more entities.

Embodiments of the invention are unique in that they validate the adherence of job execution against work instructions and a configurable set of parameters, raising the exception items for review and action well before a stationary worker could, allowing the user to monitor many work instructions simultaneously, only focusing on the work instructions that are important This unique ability is achieved through the integration, interpretation and presentation of data elements such as work instructions, spatial positioning, and real-time event detection.

The solution, through its real-time capability and configurable rules engine, has the added capability to improve the overall decision-making and resulting operational efficiencies. These efficiencies are the result of the worker being able to “see” a range of activity that was previously not possible through physical presence.

The solution illustrated herein represents the software as it has been applied to vessel cranes. The same solution can readily be applied to rail cranes and other non-vessel cargo conveyances such as rail mounted and mobile dock cranes, forklifts, and container handling and stacking equipment. The solution is equally pertinent to any environment where goods are moved from one point to another and where substantial variation exists in the execution of the instruction, i.e., the routing and timing of the conveyance or proper selection of the item to be transported in accordance with instruction, or proper execution of the instruction between conveyances and points of rest (positions).

Embodiments of the invention are directed to specific combinations of these different aspects, as well as specific embodiments related to those specific aspects. Further details regarding embodiments of the invention are provided below.

### BRIEF DESCRIPTION OF THE DRAWINGS

FIG. 1 shows a block diagram of a system according to an embodiment of the invention.

FIG. 2(a) shows a flowchart illustrating methods according to embodiments of the invention.

FIG. 2(b) shows a table illustrating exemplary instructions and attributes associated with those instructions.

FIGS. 3-5 show screenshots of graphical user interfaces according to embodiments of the invention.

FIG. 6 shows a block diagram of a computer apparatus.

### DETAILED DESCRIPTION

One embodiment of the invention is directed to a method comprising receiving work instructions for a plurality of vehicles. An exemplary work instruction might be “pick up container 5 and bring it to crane 8 for vessel A.” After work instructions are received, the method includes receiving location information (e.g., x-y coordinates) for the plurality of vehicles relative to an entity such as a crane, and generating an order for the plurality of vehicles using the location information for the plurality of vehicles and the entity. For instance, the vehicles may be present in a list, which lists the truck closest to the crane first, and the truck that is further from the crane last. This list may be present in a berth grid, which shows the trucks that are currently present on a berth, i.e. in near proximity to their assigned destination entity (or entities). The list may also include instruction numbers in the form of sequence IDs. The sequence IDs identify an intended sequence of instructions, even though the sequence IDs may or may not be sequentially displayed in the list.

In embodiments of the invention, the plurality of vehicles may comprise a plurality of trucks with cargo containers to be loaded or unloaded. The vehicles and/or containers may also comprise RF ID tags or differential GPS so that the locations of the vehicles and/or containers may be determined. The vehicles may also comprise compass and motion-sensing equipment so that speed and direction of movement may be determined. This method may be performed by a central computer apparatus such as a central server computer, which services the requests of one or more client computers, or receives data from a position detection system.

The location information that is received at the central server computer may include the x-y coordinates of the vehicles, relative to a particular entity. For example, location information may include the distance between a particular vehicle and a particular entity such as a crane, and whether the vehicle is at the left side or right side of the crane.

Work instructions may include instructions for a particular vehicle. For example, a work instruction may comprise the particular crane that a particular truck is to use to load or unload a container, a vehicle identifier such as a particular sequence number (or other sequence identifier) associated with the truck, the particular type of container that the truck is supposed to load or unload, etc.

In some embodiments of the invention, if one or more vehicles in the plurality of vehicles deviates from the work instructions that are received, or if a transition in attributes for work instructions or a special instruction is coming, then they may be highlighted for a user. The highlight may be in the form of a visual or audible alert. For example, if a truck did not arrive at the crane that it was supposed to arrive at, or if the truck is arriving too early or too late relative to other trucks, then a visual or audible alert may be provided to a user to alert the user that one or more vehicles is behaving inconsistently with the work instructions received and is not executing according to the predetermined loading or unloading plan. In another example, a special (e.g., “out of gauge”) instruction such as an instruction to load a special container may also be highlighted for the user, so that the user knows that the special instruction differs from other instructions. In each of these instances, the user needs to pay special attention to the highlighted instruction, because something special is happening. If a set of work instructions is not highlighted for the user, then the user need not pay attention to them. This system of highlighting allows the user to monitor many work instructions simultaneously, only focusing on the work instructions that are important.

Illustratively, a central server computer may receive three work instructions for trucks A, B, and C to load three 40 foot containers, and then two instructions for trucks D and E to load 20 foot containers, in that order. The work instruction (and consequently the truck) for truck D to load the first 20 foot container may be considered a “transition,” because the work instruction for truck D has a different attribute (e.g., container size) than the preceding work instructions. The work instruction for truck D may be highlighted (visually or audibly) for the user so that the user is aware that he or she needs to pay attention to this particular work instruction. Other instructions are not highlighted and the user need not focus attention on those instructions.

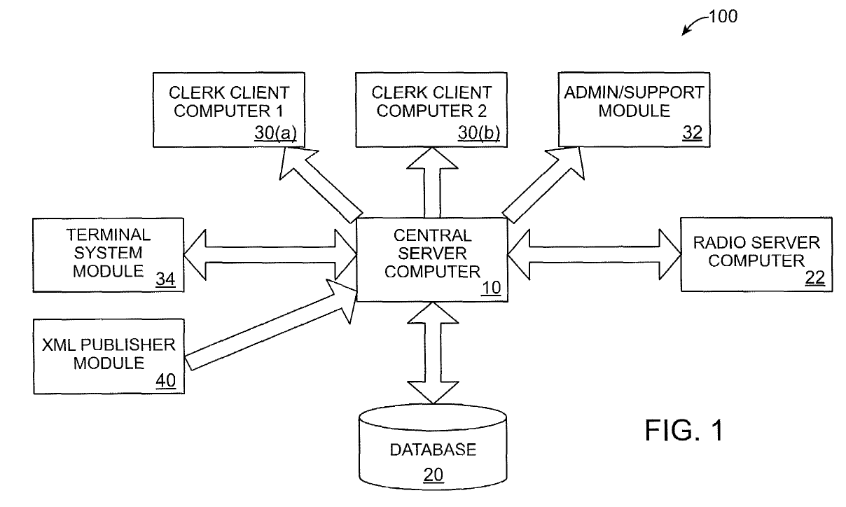

FIG. 1 shows a block diagram of a system 100 according to an embodiment of the invention. The system 100 includes a central server computer 10, which is in operative communication with a radio server computer 22, a database 20, a terminal system module 34, an XML publisher module 40, and clerk client computers 30(a), 30(b). An administration and support module 32 is also in communication with the central server computer 10.

A “server computer” as used herein, may include a powerful computer or cluster of computers. For example, the server computer can be a large mainframe, a minicomputer cluster, or a group of servers functioning as a unit. In one example, the server computer may be a database server coupled to a web server.

The central server computer 10 may comprise a processor, and a computer readable medium coupled to the processor. The computer readable medium may comprise code for receiving work instructions for a plurality of vehicles, code for receiving location information for the plurality of vehicles relative to an entity such as a crane, and code for generating an order for the plurality of vehicles using the location information for the plurality of vehicles. It may also comprise code for generating display data (and optionally sending it to a client computer), wherein the display data displays the order of the plurality of vehicles, and code for generating an alert if the execution of the work instructions is not consistent with a plan. It may also comprise code for highlighting (e.g., visually or audibly, and for a client computer coupled to it) at least one of the plurality of vehicles if the at least one vehicle is a transition, is out of gauge, or is violating a mission. The code for generating display data, code for generating an alert, or code for generating a highlight, may include any suitable data that results in the display of information, the generation of an alert, or the generation of a highlight, respectively.

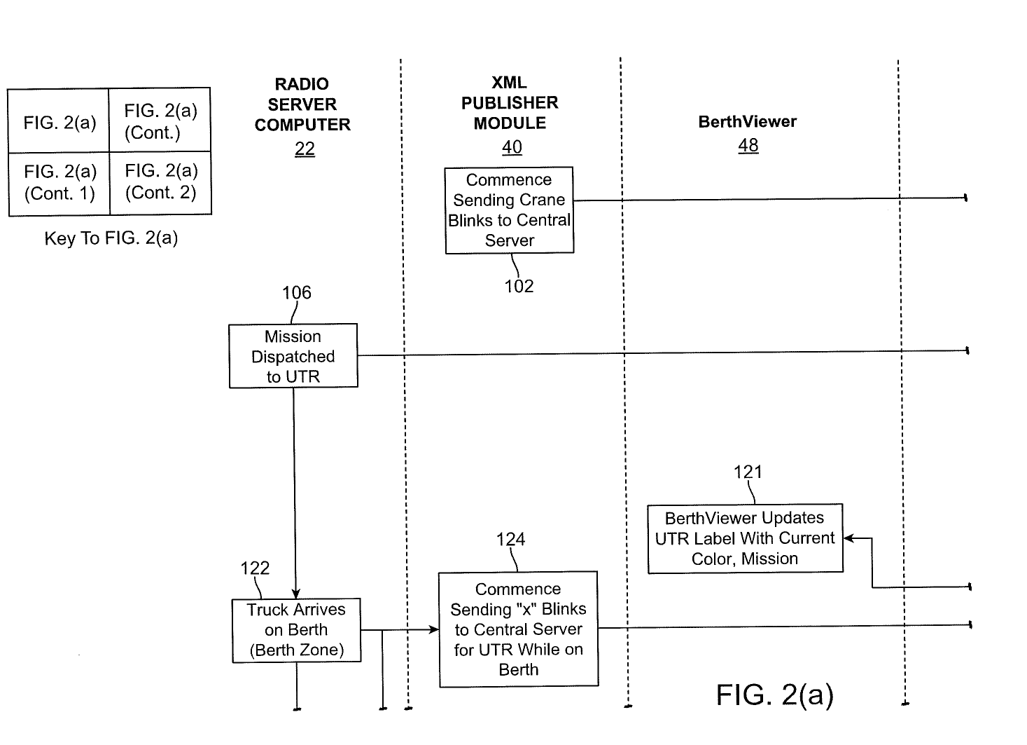

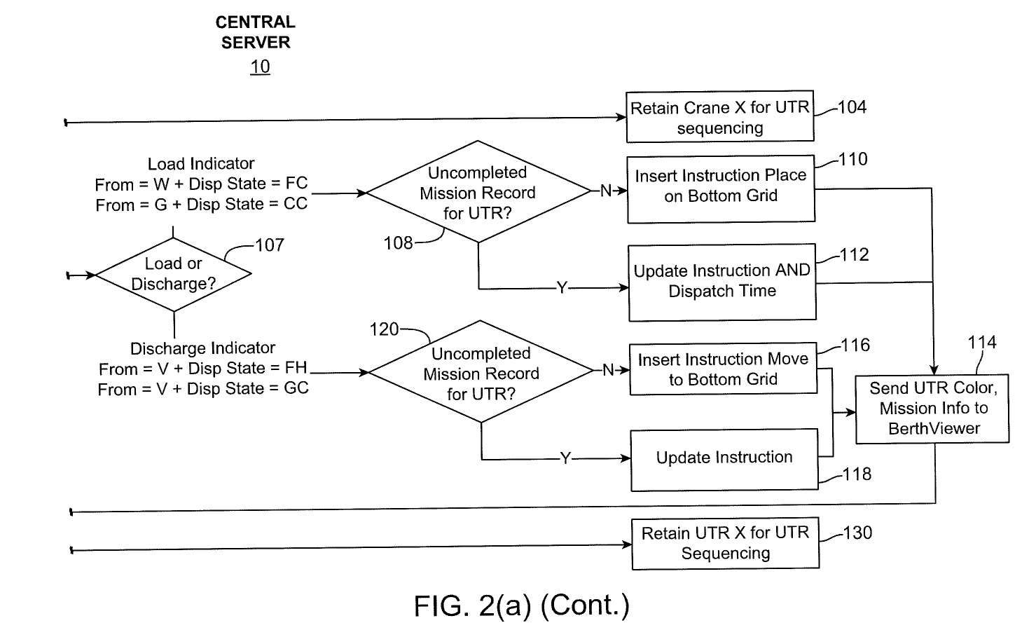

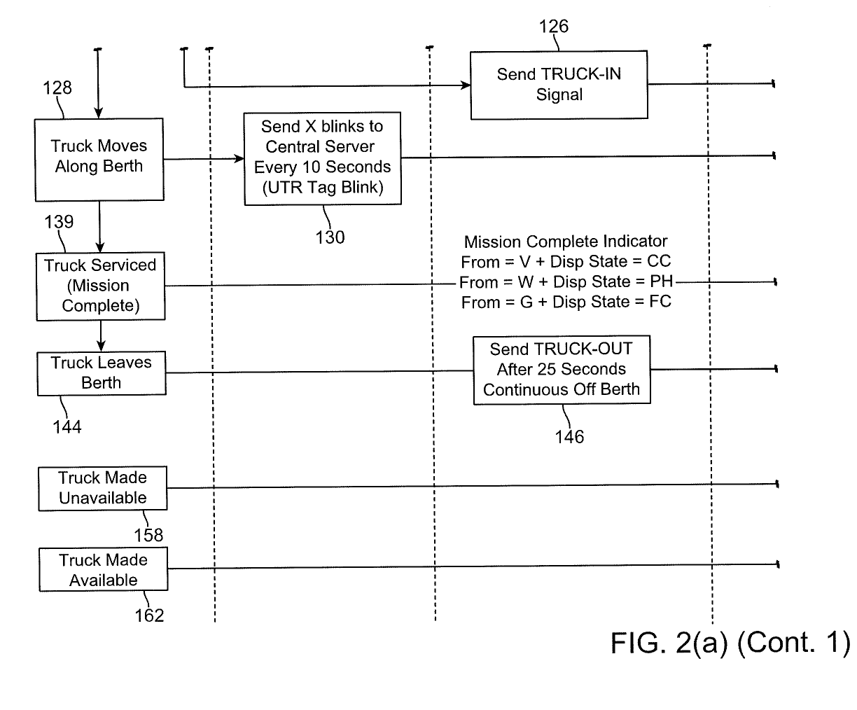

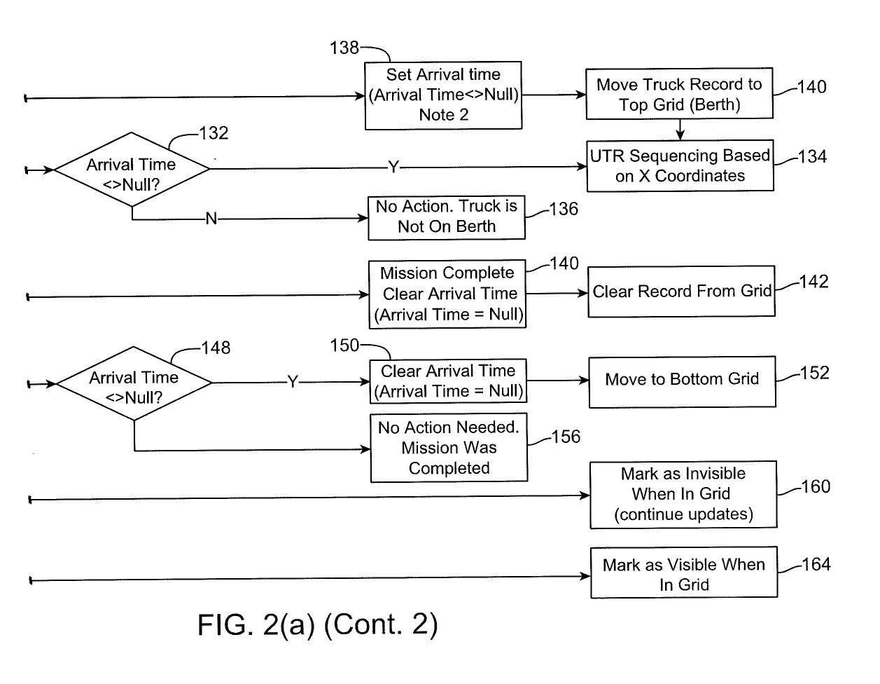

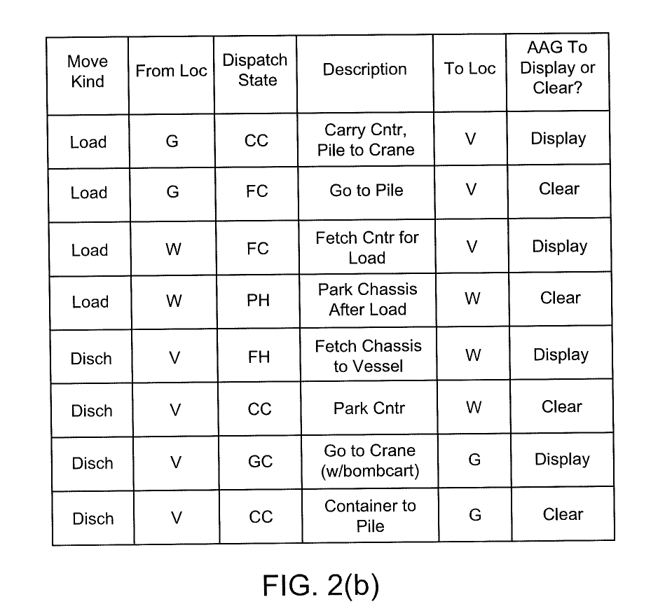

FIG. 2(a) shows a diagram illustrating methods according to embodiments of the invention. The diagram illustrates the interaction between a radio server computer 22 (a planning and execution tool or Terminal Operating System (“TOS”), an example of which is referred to as “SPARCS” commercially available from Navis), an XML publisher module 40 (commercially available from a company called WhereNet), a berth viewer 48 (e.g., a software element which can be present in terminal system module 34 or clerk client computers 30(a), 30(b)), and a central server computer 10. The process steps mentioned in the column with the radio server computer 22 may correspond to actions that a truck may take, as the truck is wirelessly interacting with the radio server computer 22. At some point, the radio server computer 22 sends a mission message including a mission to the central server computer 10 (step 102), which looks at the mission and interprets what type of mission it is. This is done at the same or substantially the same time as it is sent to the truck. After the radio server computer 22 sends the mission message, the mission message is received at the central server computer 10, and a crane is retained for truck sequencing (step 104). Some attributes of a mission may include a dispatch state, a “from” location, a “to” location, etc.

In FIG. 2(a) and elsewhere in this application, the acronym “UTR” can stand for “utility truck” or truck. A utility truck can be a truck that is used in a continuous manner to load and unload cargo from a vessel or other location. In some embodiments, a utility truck can unload cargo from a first location such as ship, and then take it to another location such as a train to unload it. After it is finished unloading the cargo onto the train, it can go back to the ship to unload another piece of cargo. Thus, in some cases, the utility truck can continuously go back and forth between first and second locations at a particular site. The utility truck and other similar utility trucks may contain RF ID tags or other wireless communication devices to allow it to wirelessly communicate with the radio server computer. Also, each truck may have a screen in it so that each truck may display instructions received by the radio server computer. The radio server computer may send a work instruction such as “bring container A to crane number 1” and the truck driver may thereafter execute the instruction. In some embodiments the truck may be any truck equipped with an RFID or other locating device and that has been assigned a work instruction through the TOS, i.e. an independent vehicle visiting the facility for the purpose of picking up or dropping off cargo.

The XML sender (or publisher) 40 can be in the form of a hardware and/or software module that can send “blinks” or signals to the central server computer 22. The signals can be sent whether or not the truck is doing anything. During the time a truck is on the berth (or another defined area, as can be determined from time to time), the central server computer 10 uses the “blink” signals and the work instruction data to determine the truck's proximity to the destination crane, relative to other trucks with the same destination. The central computer 10 then displays each record in the berth grid in its relative order of proximity to the crane, closest to farthest.

In step 106, a work instruction message including a mission is sent by the radio server computer 22 to the central server computer 10. At step 107, the central server computer 10 decides whether the instruction is an instruction to load a cargo container or an instruction to unload a cargo container.

Work instructions to load cargo may have any suitable form. For example, the work instruction message may include a load indicator to load a cargo container from wheels (W) (some containers are already on a wheeled chassis) and bring it to a vessel. The instruction message may include an instruction to fetch a container (FC). Alternatively, the instruction message may include a load indicator to load a cargo container from the ground. The work instruction message may be to fetch a container (FC) on the ground and bring it to a vessel.

Work instructions to unload cargo may have any suitable form. For example, the work instruction message may include a discharge indicator to unload a cargo container from a vessel (V). The instruction message may be to fetch a chassis (FH). Alternatively, the instruction message may include an instruction to go to a crane (GC).

If the work instruction is a load instruction, then the central server computer 10 determines whether there exists an uncompleted mission record for the truck (step 108). If not, then the central server computer 10 inserts the load instruction as a brand new mission, notes that the truck is in the yard, and it places an indicator for the truck in an appropriate place on a yard grid, which indicates trucks that are in the yard, but not yet on the berth (step 110). A “berth” may be an area where containers may be loaded or unloaded. A “yard” may be any suitable area outside of the berth. Alternatively, if the truck's mission record is incomplete, then the central server 10 updates the instruction and dispatch time (step 112). The truck may already be in the process of executing a mission and the truck's mission may be updated instead of replaced.

In some embodiments, for a discharge of cargo, if a new mission is received while there is an existing active mission, it is possible to update the mission, but not the dispatch time. For example, the radio server computer 22 can send a replacement “chassis fetch” mission when an expected container is discharged to another truck. This is transparent to the truck and the dispatch sequence is not changed. For a load, if a new mission is received while there is an active mission, then it is desirable to update the mission and update the dispatch time. All loads can be new missions, so the dispatch time needs to be updated.

If the work instruction is an unload instruction, then, as shown by decision block 120, the central server computer 10 determines whether there exists an uncompleted mission record for the truck. If not, then the central server 10 inserts the load instruction as a brand new mission, notes that the truck is in the yard, and it places an indicator for the truck in an appropriate place on a yard grid, which indicates that trucks that are in the yard, but not yet on the berth (step 116). If it is incomplete, then the central server 10 updates the instruction and the dispatch time (step 118).

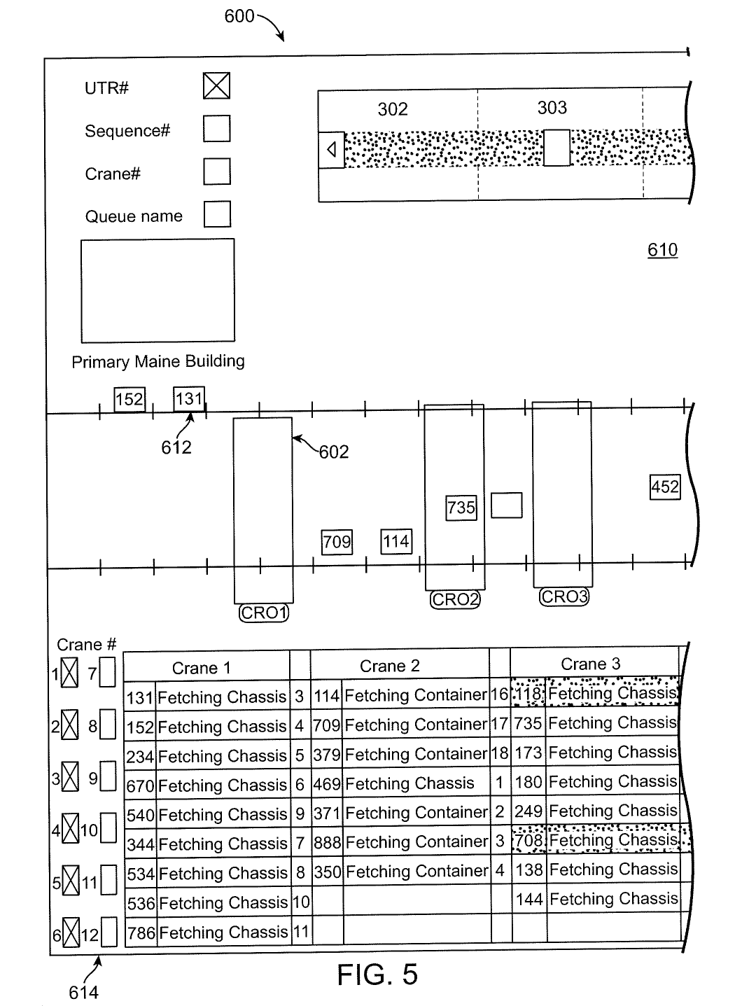

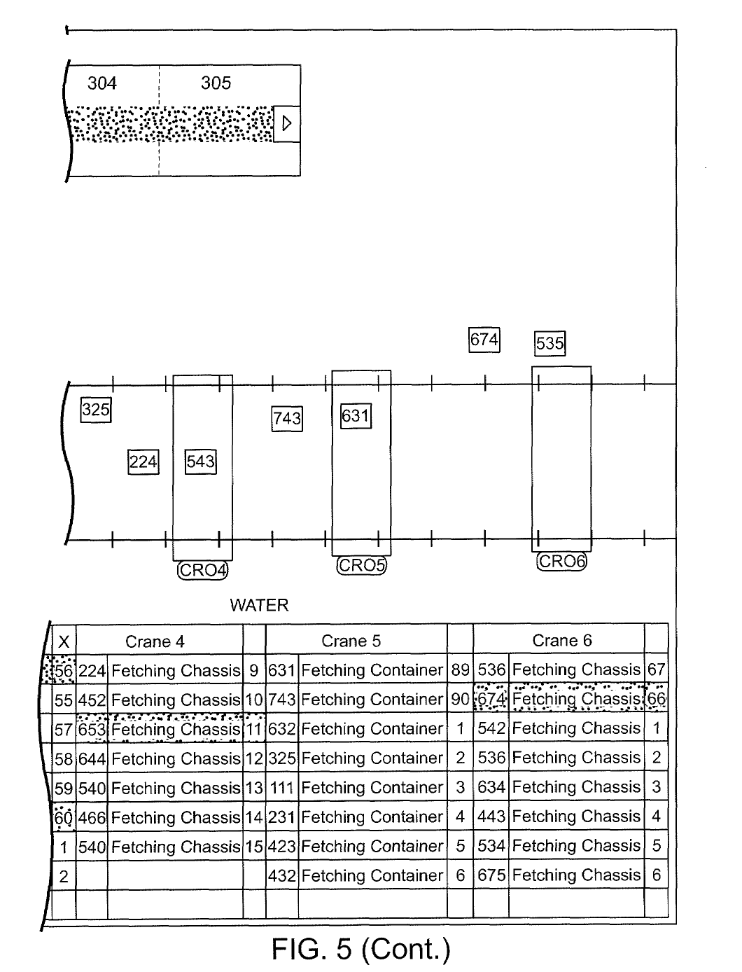

As shown in FIG. 2(a), after steps 110, 112, 116, and 118, the truck color, and mission information are sent to the berth viewer 48 (step 114). The berth viewer 48 updates the truck label with current color, and mission (step 120). The berth viewer 48 may be an application (created by a vendor such as WhereNet), which can show graphical depictions of trucks and cranes on a berth. FIG. 5, which is described in further detail below, is an example of a berth viewer.

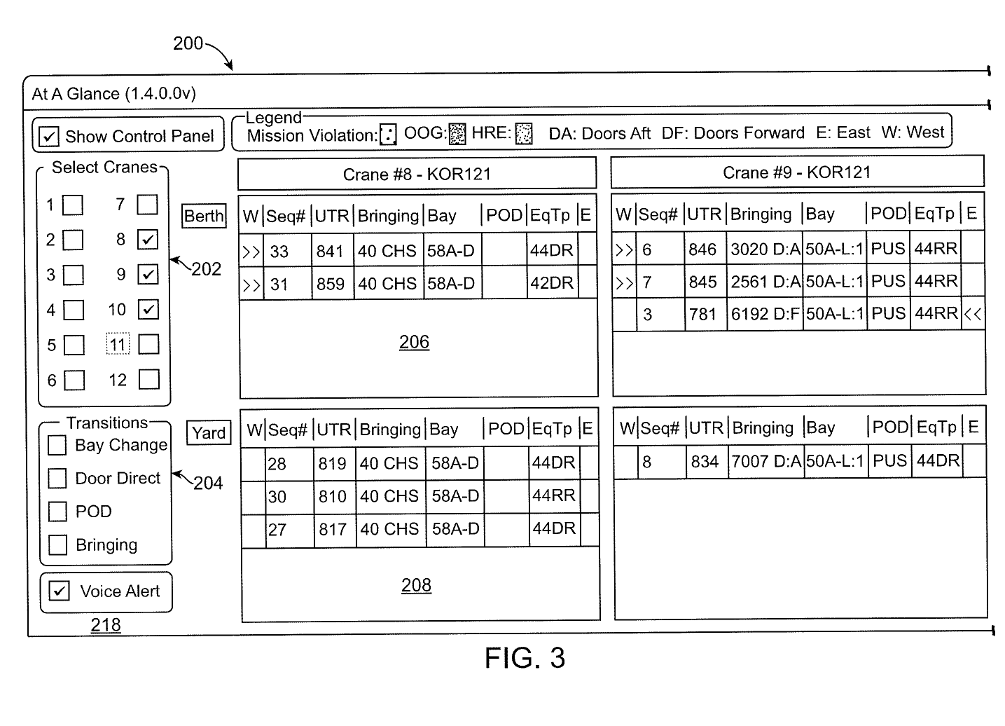

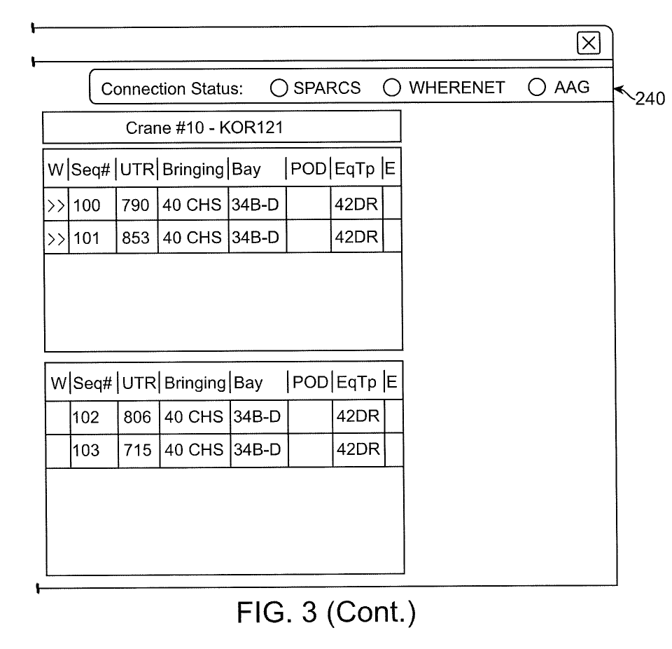

At some point, the truck arrives on the berth (step 122). The XML publisher module 40 then starts sending signals to the central server computer 10 for the truck while the truck is on the berth (step 124). The berth viewer application 48 may or may not send to the central server computer 10 a truck-in signal that the truck has entered the berth area (step 126) after 25 continuous seconds (or any other suitable time interval). The central server computer 10 acknowledges that the truck is on the berth, and then retains the truck information for truck sequencing (step 130). The central server computer 10 will also shift the truck's work instruction from a yard grid (see e.g., element 208 in FIG. 3) to a berth grid (see, e.g., element 206 in FIG. 3). The yard grid may list the trucks are in the yard (which does not contain the cranes), while the berth grid may list the trucks that are on the berth. The trucks in the berth grid may be listed from the closest to an intended crane, to the furthest from the intended crane. The trucks in the yard grid may be sequenced in the order in which work instructions are given.

When the truck is on the berth (step 122), the truck moves along the berth (step 128) and information regarding the spatial coordinates (e.g., x-y location) of the truck is received at the central server computer 10. The truck sends signals to the central server computer 10 every 10 seconds (or at any other suitable interval) in some embodiments (step 130).

At step 132, the central server computer 10 notes the arrival time of the truck on the berth. If the arrival time is null, then no action is taken as the truck is not on the berth (step 136). If the arrival time is not null, then the truck is ordered, relative to other trucks, based on its coordinates (step 134). Note that the sequence identifiers for the various trucks may or may not be in order, but the intended sequence of the trucks is visible to a user by viewing the sequence identifiers.

In step 134, the coordinates of the particular truck are noted, and are then compared against the coordinates of the other trucks on the berth that are supposed to arrive at the same crane as that truck. That truck is then listed in its appropriate position in a berth grid relative to other trucks on the grid. For example, referring to FIG. 3, there are two trucks (841 and 859) in the berth grid 206. Truck 841 has a sequence number of 33, which indicates the 33rd instruction dispatched, while truck number 859 has instruction number 31, which indicates the 31^{st} instruction dispatched. Truck 841 is closer to crane number 8 than truck 849, since it is listed above truck 849. To do this, the x-y coordinates of crane 8 can be compared against the x-y coordinates of trucks 841 and 849, and the trucks are listed in the berth grid from the one that is closest to the crane to the one that is furthest from the crane. Also, because the work instruction for sequence number 33 is before the work instruction for sequence number 31, they are not in order. There are no highlighted exceptions (e.g., a transition) in this example.

In step 138, the truck has serviced its mission, and a message including a mission complete indicator is sent to radio server computer 22, and then to the central server computer 10. In some embodiments, the message complete indicator may be: (1) from vessel, with a dispatch state of carry container; (2) from wheels with a dispatch state of parking chassis, and (3) from the ground with a dispatch state of fetching container. Other mission complete indicators may be used in other embodiments of the invention.

The central server computer 10 can set the arrival time when the truck enters the berth. If the arrival time is not equal to null, then the central server computer 10 displays the truck mission in the berth grid. Once the central server 10 receives the mission complete message, the central server 10 clears the arrival time and resets it to null (step 140). Then, the record is cleared from the grid (step 142). The truck can then conduct another mission and may receive a new work instruction.

In step 144, the truck leaves the berth. After this, the berth viewer 48 sends a truck out message after 25 continuous seconds (or any other suitable time interval) of being off of the berth (step 146). The central server 10 then determines if the arrival time is null or a value other than null (step 148). If the arrival time is not null, then the central server 10 clears the arrival time (e.g., arrival time is equal to null) (step 132). The truck is then moved to the bottom of the grid (step 152). If the arrival time is equal to null, then no action is needed as the mission is completed (step 156).

In some cases, a truck may be unavailable (step 158). In this case, it is possible to mark the truck as invisible when it is in the grid while the grid continues to update (step 160).

If the truck is available (step 164), then the truck can be marked as visible on the grid.

FIG. 2(b) shows a message display matrix. The message display matrix may include a “description” column which may include exemplary instructions. Some of the column labels surrounding each description may be referred to as a characteristic of the work description. The characteristics include “move kind” which indicates the kind of move taking place (e.g., a load or a discharge), “from loc” or from a particular location such as ground “G”, a wheeled device “W”, or a vessel “V”, “to loc” or to a particular location, and dispatch state including “CC” (carrying container), “FC” (fetching container), “PH” (parking chassis), “FH” (fetching chassis), “CC” (carrying container), and “GC” (go to crane).

FIG. 3 also shows a screenshot 200 that can be viewed by an operator operating one of the clerk client computers 30(a), 30(b) shown in FIG. 3. The screenshot 200 may include a berth grid 206 and a yard grid 208, for each crane (e.g., crane 9 in FIG. 3). As noted above, the berth grid 206 lists trucks that are on the berth and the yard grid 208 lists trucks that are on the yard.

The berth grid 206 and the yard grid 208 may include columns of information. Such information may include the truck (or UTR) number, the sequence number (which indicates when an instruction was dispatched relative to other instructions), a bringing column (which indicates that type of container that the truck is to retrieve or unload), a bay column (which indicates the particular bay that the particular container is to be retrieved from or sent to), POD or port of discharge column (which indicates the port of discharge), and EqTp or equipment type (which indicates the type of equipment used). The grids 206, 208 may also indicate the position of the truck relative to the crane (designated by the indicators “W” for west and “E” for east).

Screenshot 200 also includes a crane selection region 202. In some embodiments, selecting one or more cranes initiates the process of receiving work instructions and spatial coordinates. Also, in some cases, the berth and yard grids of only those selected cranes may be displayed. This allows the user to view only those cranes of interest.

In the screenshot 200, work instructions sent to terminal trucks are received, translated and displayed for each crane's trucks. Also, the trucks are segregated by location. As trucks are issued work instructions, they are added to the bottom yard grid 208 in the order they were dispatched. As they arrive near the crane (e.g., crane 9), their spatial coordinates cause the system to move them to the top berth grid 206. Once in the top berth grid 206, the system uses spatial coordinates to list them in order based on their physical proximity to the assigned crane. This equates to their actual physical ordering/location of the trucks relative to each crane.

Thus, a client computer operated by a user may display the screenshot 200, may receive a selection of one or more entities (e.g., cranes) to monitor, display an order for a plurality of vehicles for each of the one or more entities (e.g., as shown by the berth grid 206) on a display device, and display an intended sequence for the plurality of vehicles for each of the one or more entities (e.g., as shown by the sequence numbers or “Seq #” associated with the particular vehicles in the berth grid 206). The client computer may also generate alerts.

Computer code for performing these and the other functions described herein may be embodied in a computer readable medium in or associated with the client computer. The client computer may also include a processor coupled to the computer readable medium for processing the instructions provided by code on the computer readable medium. It may also comprise code for highlighting (e.g., visually or audibly) at least one of the plurality of vehicles if the at least one vehicle is a transition, is out of gauge, or is violating a mission.

In the screenshot 200, as noted above, the vehicle direction is also shown. Arrows (>>) can display the truck's side of approach, calculated by comparing spatial coordinates with those of the assigned cranes or other target machine, station or location. In embodiments of the invention, XML sender may also send a compass heading indicating the truck's direction of approach.

The screenshot 200 may also have a rule selection region. For example, check-boxes on the left engage the rules engine to be applied, which determines whether an exception or action of interest is occurring. In this example, the transitions that can be monitored include a “bay change,” a “door direction,” a “port of discharge,” and a “bringing” transition.

In embodiments of the invention, visual indicators may also highlight trucks that are subject to the selected rules (e.g., exception rules) and/or trucks that are violating their assigned missions. In embodiments of the invention, a combination of shading and color treatments can highlight only the tasks which the user is interested in; thus highlighting potential exceptions “at a glance.”

Another region 240 of the screenshot 200 may also indicate the connection status of the system. The user may thus be aware of whether the radio server computer, the central server computer, the berth viewer computer, and the XML sender are in communication with each other at any given time. Yet another region 208 allows a user to indicate whether or not he wants to receive a voice alert for a transition.

FIG. 3 also shows a transition selection region 204 wherein a use may select a type of transition that will be displayed on the screenshot 200.

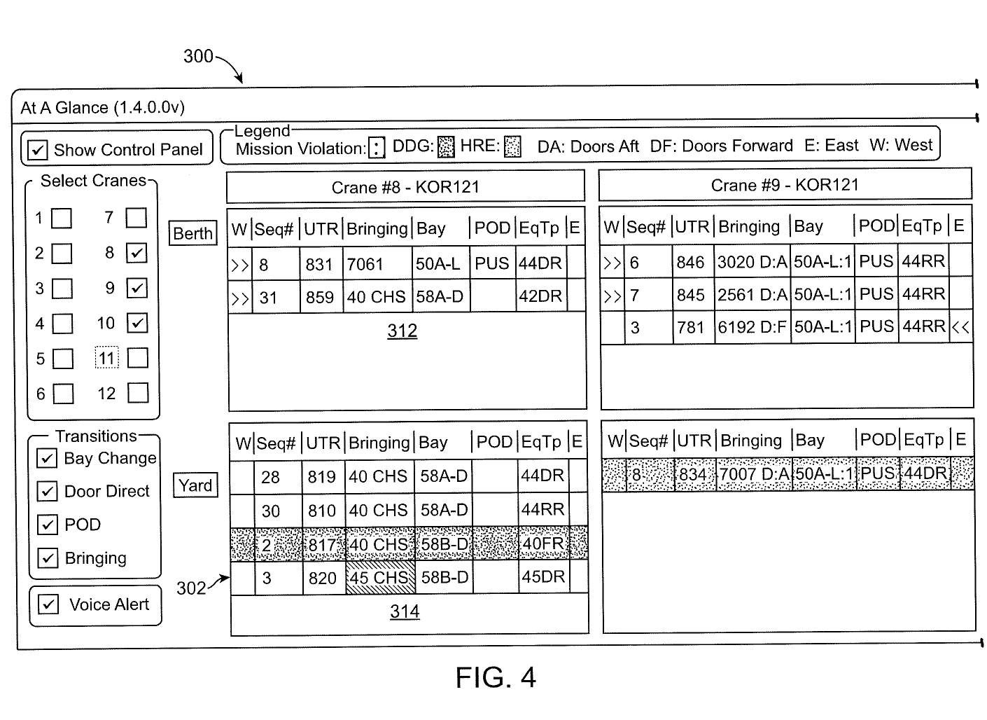

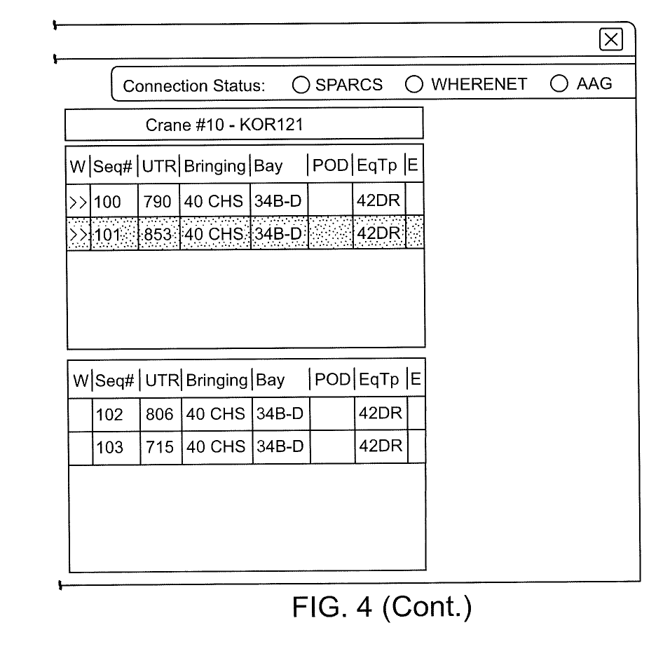

FIG. 4 shows a screenshot 300. As shown by region 302, an instruction that shows a transition can be shown, for example, by a red border and an appropriate yellow highlight. In this example, a transition from a 40 foot chassis to a 45 foot chassis is highlighted for the user. The user thus needs to pay attention to this particular work instruction as it moves from the yard grid 314 to the berth grid 312 above it. If the transition does not occur in the intended manner (e.g., the instruction for truck 820 to load the 45 foot chassis inadvertently ends up between the instructions for trucks 810 and 819 to load 40 foot chassis') when trucks 810, 819, and 820 end up on the berth and therefore the berth grid 312, then the truck 820 may load the wrong chassis and/or get in the way of the correct truck. This causes a slowdown in processing, which is undesirable.

FIG. 5 shows a “berth viewer” 610 and a berth grid 614, which is described in detail above, together in a single screenshot 600. The berth viewer 600 may show visual depictions of a number of cranes 602, and a number of trucks 612 on the berth. The berth viewer 610 shows a real time visual depiction of the activity on the berth. The berth grid 614 shows the sequence of trucks as they approach the specific crane. FIG. 5 shows a truck “118” which is highlighted a color such as red in both its visual depiction in the berth viewer 600 and the berth grid 614, because it has a “mission violation.” It is violating its mission, because the equipment it is bringing does not conform to an intended predetermined plan.

As noted above, in embodiments of the invention, various types of alerts can be provided. An alert may require worker attention. They may be visible in a graphical real time depiction, or on a columnar table depiction. The alerts may be initiated as a result of data from a radio server computer.

There may also be various types of alerts. Three exemplary types of alerts are described in further detail below. They include a “mission violation alert,” an “out of gauge” alert, and a “specific stow” or transition-type alert.

A first type of alert (which may be designated by a red highlight) may be a “mission violation” alert. A mission violation alert may be one where the particular vehicle is bringing the incorrect container or conveyance equipment. The central server computer may compare a radio server's instruction to the actual container or equipment that was actually pulled by the vehicle being used. An example of where the wrong container and equipment is pulled is when the wrong chassis size/type is selected (e.g., chassis vs. bomb cart, 20 foot vs. 40 foot, etc.). Another example is when the wrong container is pulled, based on chassis marriage (or not married) or container pickup location.

A second type of alert is an “out of gauge” alert. This indicates that a non-standard type of move is coming. For example, a particular piece of cargo may require special handling.

A third type of alert is a specific stow or a transition type of alert. An alert may be provided if a particular container is to be loaded into a specific planned position, and thus be brought up in a specific sequence or order. There are a number of different types of transitions. A transition can occur when a container with a different attribute(s) will be loaded or unloaded. When loading and unloading cargo from a ship, containers with similar attributes are often loaded or unloaded together so that work instructions with similar attributes are grouped together according to a plan. A transition can occur when a new group of containers with different attribute(s) differs from a preceding group of containers. “Attributes” may include any suitable characteristics associated with a container. They may relate to physical characteristics of a container itself (e.g., size, type, etc.), or it may relate to characteristics that are particular to that container associated with a particular instance (e.g., destination, cargo bay, etc.). Specific examples of transitions may include bay change (crane will be moving), door direction (equipment direction change), POD (port of discharge change), bringing (type of equipment/size change).

Illustratively, containers A, B, C, and D may be loaded onto a ship in order. Containers A and B may be 40 foot containers, while containers C and D may be 20 foot containers. A transition may occur at container C since the size of the containers being loaded will change. In another example using containers A, B, C, and D, containers A, B, and C may be loaded into cargo bay 1 on a ship while container D may be loaded into cargo bay 2 on the ship. Containers A, B, C, and D may have the same or different sizes in this example. A transition may occur at container D, since it is in a different cargo bay. When transitioning from cargo bay 1 to cargo bay 2, the crane will need to move. In yet another example using containers A, B, C, and D, container A may be bound for Pusan, Korea, while containers B, C, and D, may be bound for Shanghai, China. In this case, the instruction to load container B would be a transition, since containers B, C, and D, and container A have different destinations. In these examples, it is desirable to load the containers in the correct order, because of the way that the containers are unloaded when they reach their intended destinations. In each of the examples above, the user may be alerted to a particular transition so that the user is aware that the transition is coming. If, for example, there are multiple transition alerts within a group of instructions that is intended to include only one transition, this may indicate that the trucks are not arriving at the crane in order. At this point, the user may make an appropriate communication to the appropriate person responsible for the particular crane being monitored or who is executing the specific work instruction.

In the shipping industry, a typical shipyard may be over 280 acres and can have over 250 trucks running at a time loading and unloading cargo from ships. It is difficult to monitor the work instructions for all 250 trucks. It is also desirable to keep the crane moving at all times and as much as possible.

Using embodiments of the invention, the user can monitor 1000 containers, rather than only 200 containers per day (as is done conventionally). The above-described alert system allows a user to monitor a great number of work instructions simultaneously. As noted above, visual highlights such as red, yellow, and green highlights can be provided to show specific work instructions that the user needs to look at. If there are no highlights, then there is nothing that the user has to do. Some embodiments of the invention can cut labor costs by as much as 85%. In addition, embodiments of the invention allow a worker to monitor the executions of instructions from any suitable location. It is also configurable, and the user can select the types of alerts that it wants to see, and the user may also select the form that the alert will be output (e.g., voice alert and/or a visual alert).

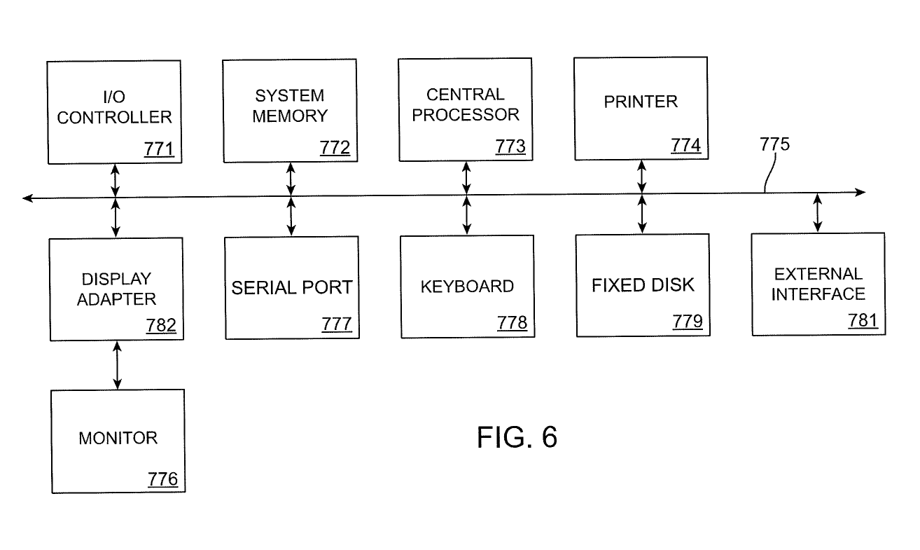

A block diagram of components of a computer apparatus is shown in FIG. 6. The components in the computer apparatus may be present in the server or client computers shown in FIG. 1. The subsystems shown in FIG. 6 are interconnected via a system bus 775. Additional subsystems such as a printer 774, keyboard 778, fixed disk 779 (or other memory comprising computer readable media), monitor 776, which is coupled to display adapter 782, and others are shown. Peripherals and input/output (I/O) devices, which couple to I/O controller 771, can be connected to the computer system by any number of means known in the art, such as serial port 777. For example, serial port 777 or external interface 781 can be used to connect the computer apparatus to a wide area network such as the Internet, a mouse input device, or a scanner. The interconnection via system bus allows the central processor 773 to communicate with each subsystem and to control the execution of instructions from system memory 772 or the fixed disk 779, as well as the exchange of information between subsystems. The system memory 772 and/or the fixed disk 779 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques.

The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, may be present on or within different computational apparatuses within a system or network. It may also reside wholly outside of any computer apparatus in some embodiments. A computer readable medium may be embodied by one or more volatile and/or non-volatile memory devices using any suitable optical, electrical, and/or magnetic means of data storage.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer implemented method comprising:
receiving work instructions for a plurality of vehicles;
receiving location information for the plurality of vehicles relative to an entity; and
using a computer, generating an order for the plurality of vehicles using the location information for the plurality of vehicles.

2. The method of claim 1 further comprising:
generating display data, wherein the display data displays the order of the plurality of vehicles.

3. The method of claim 1 wherein the work instructions are given according to a plan, wherein the plan includes grouping work instructions with similar attributes.

4. The method of claim 3 further comprising:
generating an alert if the execution of a work instruction is not consistent with the plan.

5. The method of claim 1 wherein the plurality of vehicles are a plurality of trucks with cargo containers and RF ID tags, and wherein the entity is a crane that is configured to load or unload the cargo containers.

6. The method of claim 1 further comprising highlighting at least one of the plurality of vehicles if the at least one vehicle is a transition, is out of gauge, or is violating a mission.

7. A computer readable medium comprising code executable by a processor, the computer readable medium comprising:
code for receiving work instructions for a plurality of vehicles;
code for receiving location information for the plurality of vehicles relative to an entity; and
code for generating an order for the plurality of vehicles using the location information for the plurality of vehicles.

8. The computer readable medium of claim 7 further comprising:
code for generating display data, wherein the display data displays the order of the plurality of vehicles.

9. The computer readable medium of claim 7 wherein the work instructions are given according to a plan, wherein the plan includes grouping work instructions with similar attributes.

10. The computer readable medium of claim 9 further comprising:
code for generating an alert if the work instructions are not consistent with the plan.

11. The computer readable medium of claim 7 wherein the plurality of vehicles are a plurality of trucks with cargo containers and wherein the entity is a crane that is configured to load or unload the cargo containers.

12. The computer readable medium of claim 7 further comprising:
code for highlighting at least one of the plurality of vehicles if the at least one vehicle is a transition, is out of gauge, or is violating a mission.

13. A computer apparatus comprising:
the processor; and
the computer readable medium of claim 7 coupled to the processor.

14. A computer implemented method comprising:
receiving a selection of one or more entities to monitor;
displaying on a display an order for a plurality of vehicles for each of the one or more entities; and
displaying an intended sequence for the plurality of vehicles for each of the one or more entities.

15. The method of claim 14 wherein the one or more entities are one or more cranes and the plurality of vehicles comprise trucks with cargo containers.

16. The method of claim 14 further comprising generating an alert if the order is not consistent with a predetermined plan.

17. The method of claim 14 further comprising displaying directions of the plurality of vehicles relative to a particular entity.

18. The method of claim 14 further comprising highlighting at least one of the plurality of vehicles if the at least one vehicle is a transition, is out of gauge, or is violating a mission.

19. A computer readable medium comprising code executable by a processor, the computer readable medium comprising:
code for receiving a selection of one or more entities to monitor;
code for displaying an order for a plurality of vehicles for each of the one or more entities; and
code for displaying an intended sequence for the plurality of vehicles for each of the one or more entities.

20. The computer readable medium of claim 19 further comprising:
code for highlighting at least one of the plurality of vehicles if the at least one vehicle is a transition, is out of gauge, or is violating a mission.

21. A computer apparatus comprising:
the processor; and
the computer readable medium of claim 19 coupled to the processor.
